(19) United States
(12) Patent Application Publication
(10) Pub. No.: US 2017/0237237 A1
(43) Pub. Date: Aug. 17, 2017

(54) CORONA IGNITION DEVICE WITH WIRE IGNITION TIPS

(71) Applicant: BorgWarner Ludwigsburg GmbH, Ludwigsburg (DE)

(72) Inventors: Simon Frank, Bonnigheim-Hofen (DE); Johannes Hasenkamp, Ditzingen (DE); Alexander Schenk, Waiblingen (DE); Christian Pottiez, Eppingen (DE)

(21) Appl. No.: 15/432,256

(22) Filed: Feb. 14, 2017

(30) Foreign Application Priority Data
Feb. 16, 2016 (DE) 10 2016 102 682.4

(51) Int. Cl. H01T 19/00; H01T 19/04

(52) U.S. Cl. CPC H01T 19/00; H01T 19/04

(57) ABSTRACT

A corona ignition device is described comprising a central electrode, to which at least one ignition tip leads, and an insulator, which surrounds the central electrode. According to this disclosure, provision is made for the at least one ignition tip to comprise a plurality of wires touching each other.

### RELATED APPLICATIONS

This application claims priority to DE 10 2016 102 682.4, filed on Feb. 16, 2016, which is hereby incorporated herein by reference in its entirety.

### BACKGROUND

The invention relates to a corona ignition device, and more particularly, the ignition tips thereof.

Corona ignition devices are generally known, for example, from U.S. Publication No. 2014/0261273 A1. The ignition tips of such corona ignition devices are exposed to wear, especially burn-up. Burn-up leads to the tips becoming blunt, so that it becomes increasingly difficult to achieve a corona discharge, ultimately causing the corona ignition device to fail.

In order to prolong the service life of the ignition tips, it is known, for example from U.S. Publication No. 2011/0247579 A1, to manufacture them from wear-resistant materials such as platinum metals or to coat them therewith. In U.S. Publication No. 2014/0261273 A1, ignition tips from wire have been disclosed, wherein the wires consist of platinum metal surrounded by a burn-up layer which consists of an iron-based or nickel-based alloy. The burn-up layer makes it possible to achieve a sufficiently thin wire, which will always form a good tip suitable for high field strengths, even if burn-up is considerable.

### SUMMARY

This disclosure teaches a corona ignition device having tips whose service life is increased.

The ignition tip of a corona ignition device according to this disclosure comprises a plurality of wires touching each other. The wires can be twisted or stranded together or they may lie adjacent to each other extending in parallel in a straight line. As a result, there are the ends of several wires at the end of the ignition tip. High field strengths can form at the end of each wire, thereby making it possible for a corona discharge to form. The ignition tip will remain functional and initiate a corona discharge, as long the high field strengths are created on at least one wire end.

According to this disclosure, a corona discharge often forms on only one single wire end of a corona ignition device so that only this one wire end is subject to a burn-up. As this wire becomes shorter as a result of the burn-up, large field strengths will then form at another wire end of this ignition tip and thus a corona discharge is ensured. Thus the service life of the ignition tip is increased in that the stress through burn-up is distributed across a number of wire ends.

An advantageous refinement of this disclosure provides for the wires to be formed of an alloy based one or more platinum metals. Platinum metals are Ru, Rh, Pd, Os, Ir and Pt. Platinum metals have an advantageously high resistance to burn-up. Especially suited alloys are iridium-based alloys, for example iridium-based alloys with 3 to 30%-by-weight rhodium.

A further advantageous refinement of this disclosure provides for the plurality of wires to be surrounded by a coating of a different material. The coating stabilizes the ignition tip, thereby permitting the use of thinner wires. This is advantageous because the field strengths at the end of a wire are larger for thinner wires. The different material may have less burn-up resistance than the material of the wires. In this way, the coating, in a forward area of the ignition tip, is constantly removed through burn-up, so that the wire ends are always exposed. The coating may, for example, be formed of an alloy based on one or more transition metals, for example, an iron-based alloy, a nickel-based alloy or a chrome-based alloy.

An ignition tip according to this disclosure may, for example, have only two wires or alternatively three or more wires, for example 4 to 10 wires. The wires may all be identical, but this is not mandatory. For example, it is possible to arrange the wires around one wire arranged in the center of the ignition tip. This wire arranged in the center may form a core and may be formed of a different material and/or may have an increased diameter in order to mechanically stabilize the ignition tip. A thicker wire in the center can make it easier to twist the thinner wires around it. If the thicker wire in the center is formed from a material with a burn-up-resistance lower than that of the wires surrounding it, it will burn down quickly, so that the formation of a corona is not obstructed because of its larger diameter, and good conditions for the formation of a corona practically almost always prevail on one of the wires surrounding it.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an embodiment of a corona ignition device;

FIG. 2 shows a sectional view of FIG. 1;

FIG. 3 shows a partially sectional view of an embodiment of an ignition tip; and

FIG. 4 shows a top view of the ignition tip.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

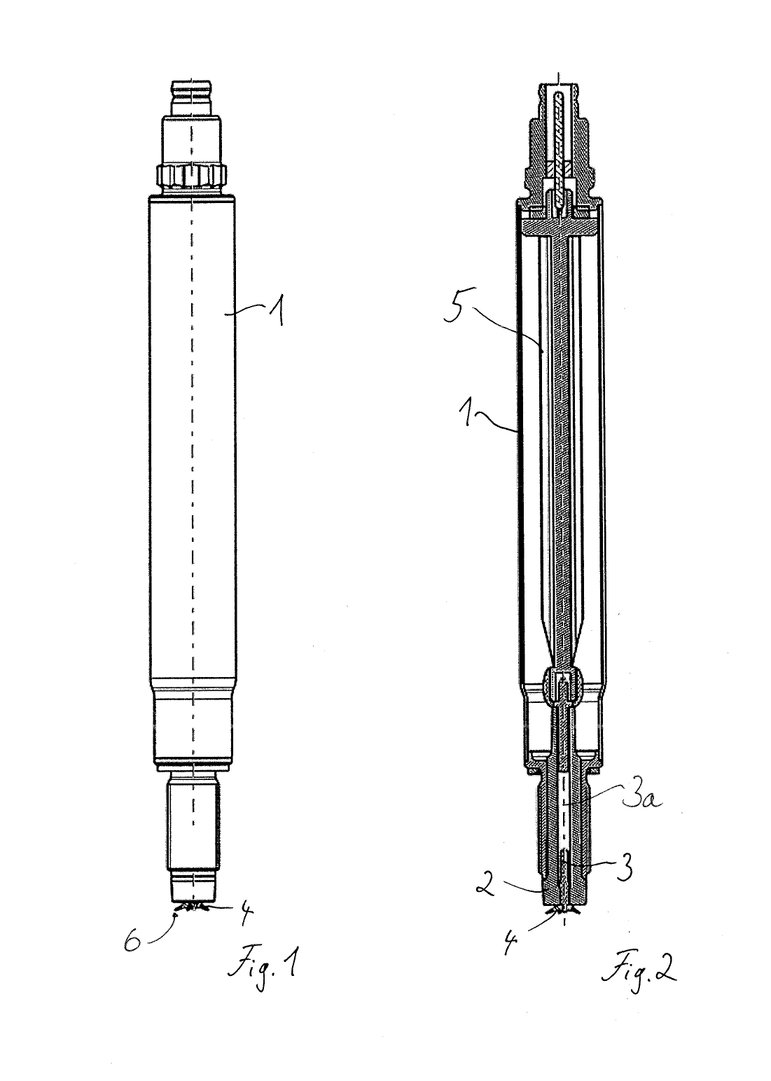

The corona ignition device shown in FIGS. 1 and 2 generates a corona discharge for the purpose of igniting fuel in a combustion chamber of an engine. The corona ignition device has a holder 1, which surrounds an insulator 2. Inside the insulator 2 there is a central electrode 3, which supports a head 4 with several ignition tips 6, for example in that the ignition tips are plugged into the head 4. A section 3a of the central electrode 3 may be formed of electrically conductive glass, which acts as a seal.

The central electrode 3 together with the insulator 2 and the holder 1 forms a capacitance, which is connected in series with a coil 5 connected to the central electrode 3. This capacitance and the coil 5 are part of an oscillating circuit through which, if excited, corona discharges can be generated at the ignition tips 6 of the ignition head 4. In the embodiment shown the holder 1 forms a housing in which the coil 5 is arranged. There is no need for a closed housing in which to arrange the coil. In the embodiment shown the coil 5 is arranged in a metal housing formed by the holder 1, and this houses the insulator body 2. Alternatively, the coil 5 may be arranged in some other place and may for example be connected to the central electrode 3 via a cable.

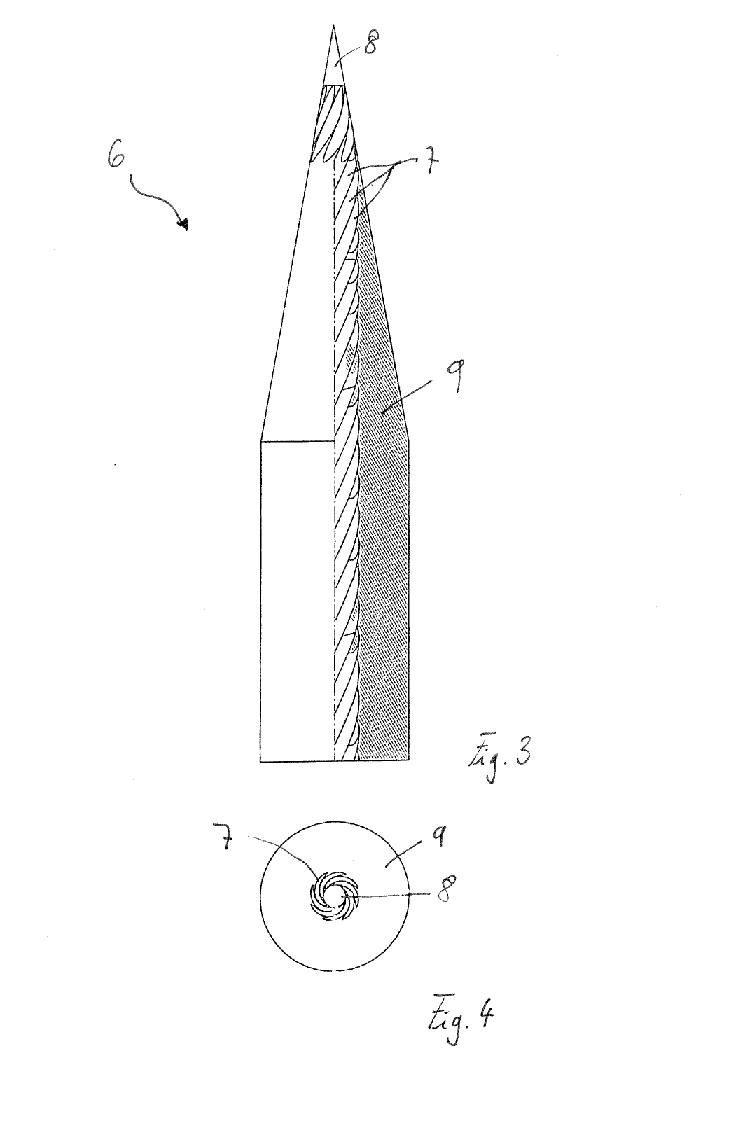

One of the ignition tips 6 of this corona ignition device is shown enlarged in FIGS. 3 and 4. The ignition tip comprises a plurality of wires 7, 8 which are touching each other and which all extend along the longitudinal direction of the ignition tip. The wires 7, 8 are surrounded by a coating 9. The ignition tip 6 may be mechanically tapered to a point, before it is placed into operation for the first time.

The wires 7, 8 are twisted or stranded. One of the wires 8 may be arranged in the center and surrounded by the other wires 7, thereby forming a core. If a central wire exists, this may be thicker than the other wires. A thicker wire 8 in the center of the ignition tip can mechanically stabilize the same.

If a thicker wire 8 is arranged in the center of the ignition tip, this may contain less burn-up-resistant material than the wires 7 surrounding it. The wires 7 may, for example, be manufactured from an alloy based on platinum metals, for example from an iridium-based alloy. If a thicker wire 8 is arranged in the center of the ignition tip, this may be formed of, for example, an alloy based on transition metals, such as an alloy based on iron, nickel or chrome.

The wires 7, 8 may be coated, twisted or stranded or generally arranged in many different configurations.

Following twisting or stranding of the wires 7, 8 they can be encased in a coating, such as with an alloy based on one or more transition metals. Iron-based, nickel-based or chrome-based alloys are particularly suitable.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SYMBOLS

1 holder
2 insulator
3 central electrode
4 ignition head
5 coil
6 ignition tips
7 wire
8 wire
9 coating

What is claimed is:

1. A corona ignition device, comprising:
a central electrode leading to at least one ignition tip; and
an insulator surrounding the central electrode;
wherein the at least one ignition tip comprises a plurality of wires touching each other.

2. The corona ignition device according to claim 1, wherein the wires are surrounded by a coating made of a different material than the wires.

3. The corona ignition device according to claim 2, wherein the different material is formed predominantly of one or more transition metals.

4. The corona ignition device according to claim 1, wherein the wires are twisted or stranded together.

5. The corona ignition device according to claim 4, wherein the plurality of wires comprises a central wire and remaining wires, the remaining wires being twisted or stranded around the central wire.

6. The corona ignition device according to claim 5, wherein the central wire is thicker than the remaining wires.

7. The corona ignition device according to claim 5, wherein the central wire is formed of a material having less burn-up-resistance than the remaining wires.

8. The corona ignition device according to claim 1, wherein the plurality of wires comprises a central wire and remaining wires, the central wire being formed of a different material than the remaining wires.

9. The corona ignition device according to claim 1, wherein at least some of the wires are formed of an alloy based on one or more metals of the platinum group.

10. The corona ignition device according to claim 1, wherein the central electrode supports a head to which the ignition tips are attached.
